(19) United States
(12) Patent Application Publication
(10) Pub. No.: US 2006/0233271 A1
(43) Pub. Date: Oct. 19, 2006

(54) Method and apparatus for channel estimation in distributed transmit diversity systems

(76) Inventors: Alpaslan Gence Savas, San Diego, CA (US); Wanshi Chen, San Diego, CA (US); Anthony C.K. Soong, Superior, CO (US); Shiau-He Shawn Tsai, San Diego, CA (US)

Correspondence Address: COATS & BENNETT, PLLC, P O BOX 5, RALEIGH, NC, 27602, US

(21) Appl. No.: 11/321,647

(22) Filed: Dec. 29, 2005

Related U.S. Application Data
(63) Continuation-in-part of application No. 11/106,092, filed on Apr. 14, 2005.
(60) Provisional application No. 60/711,525, filed on Aug. 26, 2005.

(51) Int. Cl. H04K 1/10

(52) U.S. Cl. 375/260

(57) ABSTRACT

A distributed transmit diversity system based on OFDM signaling transmits a broadcast/multicast service signal from one or more first base stations and from one or more second base stations, wherein the first and second base stations transmit orthogonalized pilots. Correspondingly, a remote receiver, e.g., a mobile station, resolves the orthogonal pilots and makes independent channel estimates relative to the first and second base stations for improved diversity reception. Pilots are orthogonalized between the first and second base stations by using orthogonal space-time or space-frequency block coding. For example, in one embodiment, a first pilot tone pair is interleaved with data tones in the OFDM data blocks being transmitted from the first base stations, while an orthogonal second pilot tone pair is interleaved with data tones in the same OFDM data blocks being synchronously transmitted from the second base stations.

### RELATED APPLICATIONS

This application claims priority under 35 U.S.C. § 120 as a continuation-in-part of the pending U.S. patent application entitled “Distributed Transmit Diversity In A Wireless Communication Network,” filed on 14 Apr. 2005 and assigned Ser. No. 11/106,092, which is incorporated by reference herein, and further claims priority under 35 U.S.C. § 119(e) from the U.S. provisional patent application, entitled “Pilot Transmission For Distributed Transmit Diversity For The Enhanced BCMCS,” filed on 26 Aug. 2005 and assigned Ser. No. 60/711,525, which also is incorporated by reference herein.

### BACKGROUND OF THE INVENTION

The present invention generally relates to wireless communication networks, and particularly relates to orthogonal pilot transmission in distributed transmit diversity systems.

Transmissions from a given network transmitter, e.g., transmissions within a given radio sector, generally divide into two types: unicast transmissions targeted to individual subscribers and broadcast/multicast transmissions targeted to a potentially large number of subscribers. That is, a broadcast/multicast service sends content from a single source simultaneously to multiple subscribers within a given service area. As such, broadcast/multicast services make more efficient use of the limited air interface and are ideally suited for the transmission of high-rate multimedia content.

With the proliferation of data-oriented subscribers, and with the increasing range of content made available through the public data networks, e.g., the Internet, broadcast and multicast services represent an area of increasing interest and ongoing development in wireless communications. For example, the 1x EV-DO wireless communication network standards support the delivery of Broadcast and Multicast Services (BCMCS). The first revision of the 1xEV-DO standards (Rev. 0), supports broadcasting/multicasting at a physical data rate of 614 Kbps. (Note that the average data rates enjoyed by individual subscribers may be lower, depending upon the particular reception conditions enjoyed by each such subscriber.

### SUMMARY OF THE INVENTION

A distributed transmit diversity system based on Orthogonal Frequency Division Multiplexing (OFDM) signaling transmits a broadcast/multicast service signal from one or more first base stations and from one or more second base stations, wherein the first and second base stations transmit orthogonalized pilots. Correspondingly, a remote receiver, e.g., a mobile station, resolves the orthogonal pilots and makes independent channel estimates relative to the first and second base stations for improved diversity reception. Pilots are othorgonalized between the first and second base stations by using orthogonal space-time or space-frequency block coding. For example, in one embodiment, a first pilot tone pair is interleaved with data tones in the (OFDM) data blocks being transmitted from the first base stations, while an orthogonal second pilot tone pair is interleaved with data tones in the same OFDM data blocks being synchronously transmitted from the second base stations.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication network that is configured for orthogonal pilot transmission in the context of offering broadcast/multicast services using distributed transmit diversity.

FIG. 2 is a block diagram of one embodiment of the base stations illustrated in FIG. 1.

FIG. 3 is a block diagram of block-based OFDM data transmission in support of broadcast/multicast service transmission.

FIG. 4 is a diagram of orthogonal pilots according to one embodiment of orthogonal pilot signal generation and transmission as taught herein.

FIG. 5 is a diagram of another embodiment of orthogonal pilot signal generation and transmission.

FIG. 6 is a block diagram illustrating one embodiment of a mobile station that is configured for channel estimation based on processing orthogonal pilots in a distributed transmit diversity environment.

### DETAILED DESCRIPTION OF THE INVENTION

While details for specific embodiments appear later herein, it should be understood that such details stand as examples of a broader method of enabling channel estimation by a remote receiver relative to a broadcast/multicast service being transmitted via orthogonal frequency division multiplexing (OFDM) from one or more first base stations and one or more geographically separated second base stations. Broadly, the method comprises generating orthogonal first and second pilot tones, and transmitting the first pilot tones from the one or more first base stations and transmitting the second pilot tones from the one or more second base stations.

The first and second base stations may comprise 1xEV-DO base stations in a 1xEV-DO communication network, and transmitting the first pilot tones from the one or more first base stations and transmitting the second pilot tones from the one or more second base stations may comprise transmitting orthogonal pilot tones from the first and second base stations according to a desired space-time or space-frequency block coding. That is, the distributed transmit diversity channel estimation methods taught herein may be embodied in a High Data Rate network using geographically distributed base stations to provide the same BCMC service content to one or more mobile stations, wherein the one or more first base stations and one or more second base stations transmit orthogonal pilot signals. Doing so allows each receiving mobile station to independently estimate composite propagation channels relative to the first and second base stations.

For example, transmitting first pilot tones from the one or more first base stations and transmitting the second pilot tones from the one or more second base stations may comprise interleaving a first pilot tone pair with data tones being transmitted from the first base stations and interleaving the orthogonal second pilot tone pair with data tones being transmitted from the second base stations. More broadly, transmitting orthogonal pilot tones from the one or more first base stations and the one or more second base stations comprises transmitting a first space-time or space-frequency pilot code sequence from the first base stations and transmitting a second space-time or space-frequency pilot code sequence from the second base stations. In at least one embodiment, transmitting a first pilot code sequence from the first base stations and transmitting a second pilot code sequence from the second base stations comprises alternately transmitting the first and second pilot code sequences from the first base stations, while alternately transmitting the second and first pilot code sequences in the same data blocks of a BCMC service signal being transmitted from the first and second base stations.

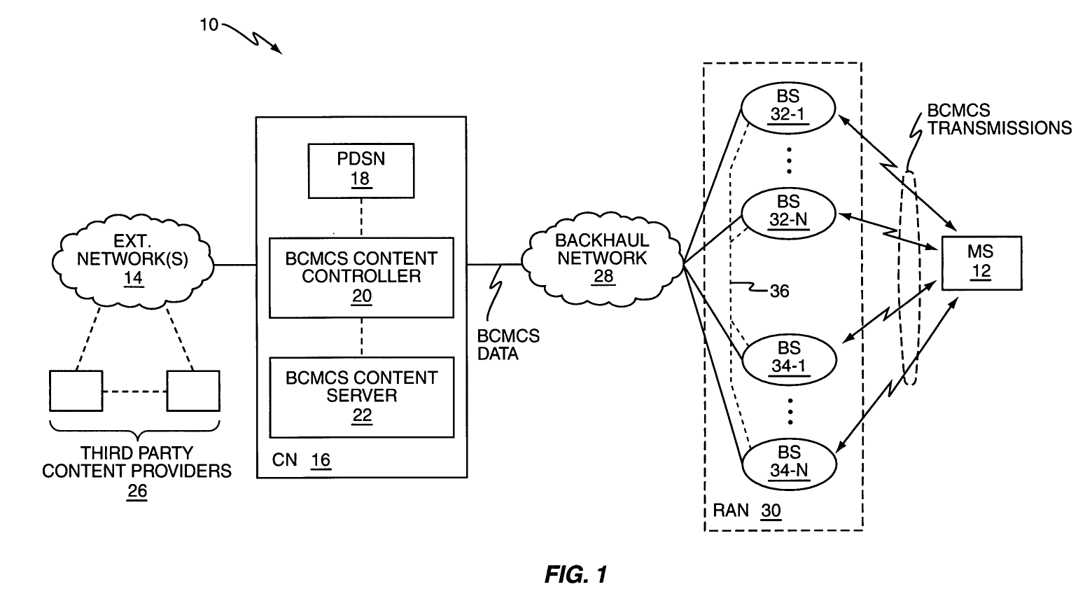

With the above points in mind, FIG. 1 illustrates a wireless communication network 10, which, by way of non-limiting example, comprises a 1x Evolution Data Only (1xEV-DO) wireless communication network. Functionally, the network 10 communicatively couple mobile stations 12 one is shown for simplicity—to one or more external networks 14. The external network(s) 14, which may comprise the Internet, for example, may provide content for broadcast/multicast (BCMC) services.

In more detail, the network 10 comprises a Core Network (CN) 16, which includes one or more Packet Data Serving Nodes (PDSNs) 18, one or more broadcast/multicast content controllers 20 and broadcast/multicast content servers 22, which may provide broadcast/multicast from third party content providers 26. Such content is transferred through a backhaul network 28 to a Radio Access Network (RAN) 30, which includes one or more first base stations 32-1 . . . 32-N, and one or more second base stations 34-1 . . . 34-N. The base stations 32 and 34 may be communicatively coupled together, such as by sidehaul links 36 and/or by centralized data and control signaling from the CN 16.

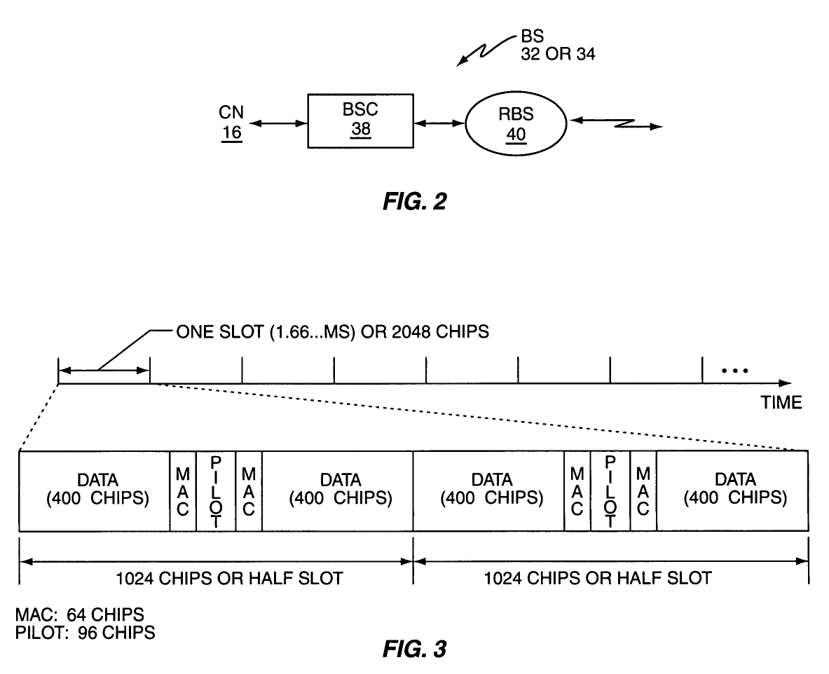

Regardless, it should be understood that the first base stations 32 and the second base stations 34 may be the same in terms of general structure and configuration, and are differentiated herein for purposes of explaining the transmission of orthogonal pilot signals from geographically disperse base stations in the context of BCMC services transmit diversity. As a further note regarding the base stations 32 and 34, those skilled in the art will appreciate that the base stations 32 and 34 can be implemented in a variety of architectures, such as integrated architecture wherein the base station controllers and radio base station resources are co-located. Alternatively, the base stations 32 and 34 can be implemented as base station systems, such as shown in FIG. 2, comprising a base station controller 38, which is coupled to the CN 16, and a radio base station 40, which includes radio transceiver resources. The base station controller 38 may be referred to as a radio network controller and the radio base station 40 may be referred to as a base transceiver station, a Node B, etc.

The radio base station transceiver resources are used to support the air interface between the RAN 20 and the mobile stations 12, and may be used to transmit BCMC services to the mobile station 12. To improve reception of BCMC services by the mobile station 12, the BCMC service content can be transmitted by the one or more first base stations 32 and by the one or more second base stations 34, wherein one or more of the second base stations 34 are geographically spaced apart from one or more of the first base stations 32. In this context, the network 10 is configured as a broadcast/multicast service system enabling channel estimation by the mobile station 12, or, more generally, any remote receiver.

In particular, in one or more embodiments, the network 10 is configured to operate as a distributed transmit diversity system, wherein the same BCMC service is transmitted via orthogonal frequency division multiplexing (OFDM) signals from spaced-apart base stations. To enable the receiving mobile stations to exploit the benefits of distributed transmit diversity in this context, the first base stations 32 are configured to transmit first pilot tones in conjunction with transmitting data tones corresponding to the broadcast/multicast service, and the second base stations 34 are configured to transmit second pilot tones orthogonal to the first pilot tones, in conjunction with transmitting data tones corresponding to the broadcast/multicast service. As was noted earlier, the base stations 32 and 34 may comprise 1xEV-DO base stations in a 1xEV-DO communication network.

FIG. 3 illustrates one embodiment of block-based data transmission via OFDM signaling for a BCMC services signal being transmitted by the first base stations 32 and the second base stations 34. While the data content generally is the same in each BCMC services signal being transmitted from each of the first base stations 32 and each of the second base stations 34, the pilot signals are different in that the pilot signals transmitted from the first base stations 32 are orthogonal with respect to the pilot signals transmitted from the second base stations 34.

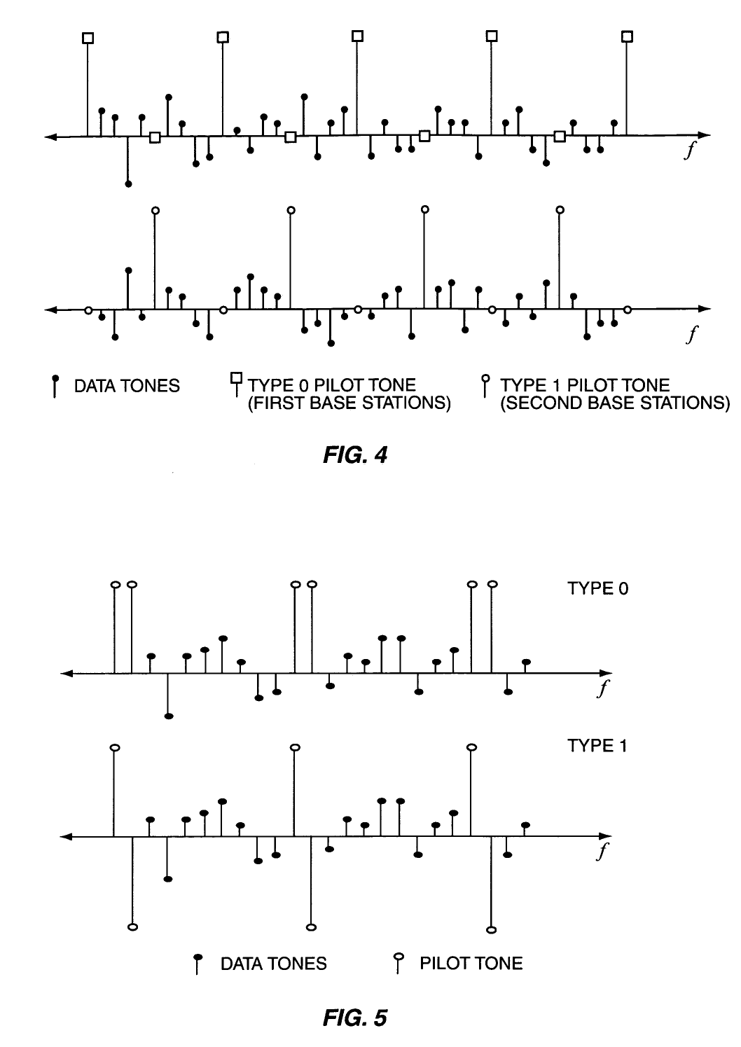

For example, FIG. 4 illustrates one embodiment of orthogonal pilot signal generation that may be adopted by the network 10, where the first and second base stations 32 and 34 are configured to transmit an orthogonalized ON/OFF pilot pattern across OFDM pilot tones. The pilot tones are interleaved with the data tones comprising the OFDM transmission blocks used for transmitting the BCMC services signal. The remote receivers, e.g., the mobile station 12, can consider the first and second base stations 32 and 34 as type 0 and type 1 base stations.

With this perspective, for data block n, the observed fading channel coefficients from the type 0 and type 1 base stations are denoted as h1(n) and h0(n), respectively. The transmitted pilot tones of the type 0 and type 1 base stations are denoted as p0(n) and p1(n), respectively. According to one embodiment of the orthogonal pilot transmission methods taught herein, the even elements of p0(n) and the odd elements of p1(n) are set to zero.

The received even pilots are
yₖ(n)=h_{0,k}(n)p_{0,k}(n)+vₖ(n) (1)
where k is even, and the received odd pilots (i.e., k is odd) are
yₖ(n)=h_{1,k}(n)p_{1,k}(n)+vₖ(n) (2)

Note that the subscript k in Eqs. (1) and (2) denotes the OFDM frequency tone index, and the vₖ (n) terms represent noise samples. It will be understood that with the geographically separated type 0 and type 1 base stations, the fading channels experienced by the OFDM signals being transmitted from the type 0 and type 1 base stations are independent, and the use of orthogonal pilot signals allows the mobile station 12 to independently resolve and estimate the type 0 pilots and type 1 pilots. That is, by virtue of receiving pilot signals from the first and second base stations 32 and 34 that are orthogonal relative to each other, the mobile station 12 can estimate a composite propagation channel relative to all of the first base stations 32, and can independently estimate a composite propagation channel relative to all of the second base stations 34.

Further, as was noted earlier herein, the first base stations 32 can alternate their operation between type 0 and type 1 pilot transmissions, and the second base stations 34 can adopt a complementary alternation between type 1 and type 0 pilot transmissions. Thus, in at least one embodiment, the first base stations 32 are configured to alternately transmit first and second pilot tones, such as first and second pilot tone pairs, and the second base stations 34 are configured to alternately transmit the second and first pilot tones. Thus, when the first base stations 32 transmit the first pilot tones the second base stations 34 transmit the second pilot tones, and when the first base stations 32 transmit the second pilot tones the second base stations 34 transmit the first pilot tones. For example, the first and second base stations 32 and 34 can independently or jointly map type 0/1 to even/odd pilots allocations in different data blocks in the BCMC services signal. As one example,
Option 1: Block 0, Type [0, 1]=[Even, Odd] pilots; Block 1, Type [0, 1]=[Odd, Even] Pilots
   Option 2: for all blocks, Type [0, 1]=[Even, Odd] pilots
      In these, and in other embodiments where the pilot codes alternate or otherwise change between the first and second groups of base stations 32 and 34, it should be noted that the first and second base stations 32 and 34 can be configured to coordinate the use of different pilot codes using the sidehaul links 36 shown in FIG. 1.

More broadly, whether or not the sidehaul links 36 are used for coordination, the one or more first and second base stations 32 and 34 can be configured to alternate between orthogonal first and second pilot space-time or space-frequency codings. In other words, when first base stations 32 are transmitting using the first coding, the second base stations 34 are transmitting using the second coding, and vice versa. Generally, the first and second base stations 32 and 34 can be configured to transmit orthogonal first and second pilot tones, such as orthogonal pilot tone pairs, synchronously in each of a plurality of successive broadcast/multicast service data blocks. FIG. 5 illustrates one embodiment of the transmission of orthogonal tone pairs from the first and second base stations 32 and 34.

As shown in FIG. 5, instead of using ON/OFF pilots, the first and second base stations 32 and 34 in this embodiment use orthogonal codes—such as length 2 codes—to obtain orthogonal pilots. From the perspective of a remote receivers, the received pilots-pair are
y₂ₖ(n)=h_{0,2k}(n)p_{0,2k}(n)+h_{1,2k}(n)p_{1,2k}(n)+v₂ₖ(n) (3)
and
y₂ₖ₊₁(n)=h_{0,2k+1}(n)p_{0,2k+1}(n)−hd 1,2k+1(n)p_{1,2k+1}(n)+v₂ₖ₊₁(n) (4)
Typically, the frequency separation between adjacent OFDM tones is relatively small. For instance, in a 1xEV-DO BCMC services embodiment of the network 10, the tone separation is 3.84 kHz. As a result, it is reasonable to assume the propagation channels across two adjacent tones are the same. That is, h_{i,2k}(n)=h_{i,2k+1}(n),i=0, 1. Therefore, the estimated channels for the pilot tone-pair for each base station type can be estimated for type 0 base stations as

$$\frac{{y}_{2 k} ( n ) + {y}_{2 k + 1} ( n )}{2} \qquad ( 5 )$$

and for type 1 base stations as

$$\frac{{y}_{2 k} ( n ) - {y}_{2 k + 1} ( n )}{2} \qquad ( 6 )$$

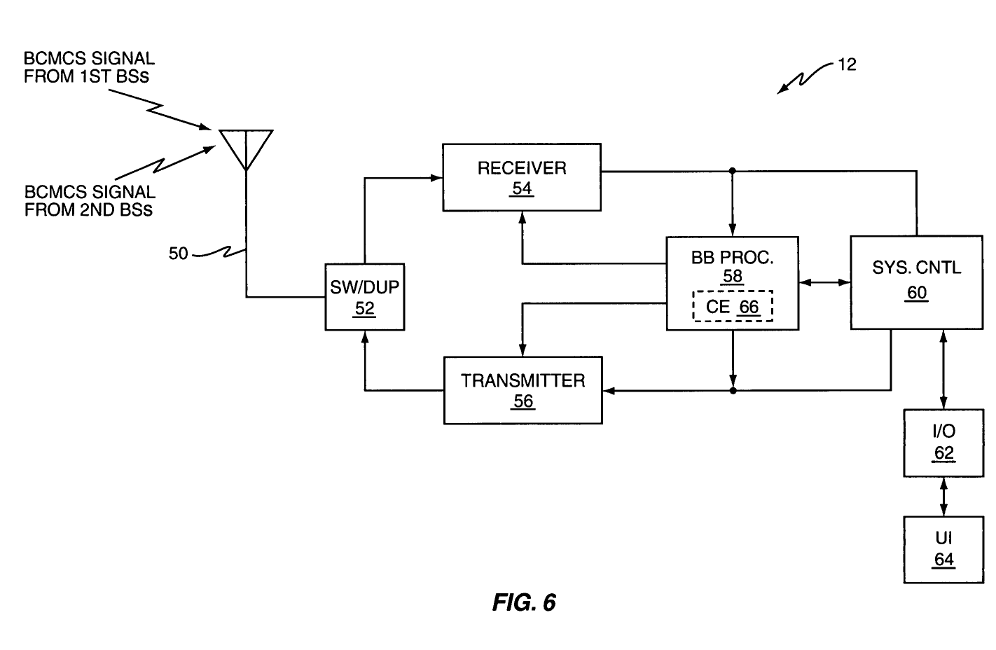

FIG. 6 illustrates one embodiment of the mobile station 12, which, by way of non-limiting example, can comprise a 1xEV-DO terminal configured for operation in a 1xEV-DO wireless communication network. The mobile station 12 is configured to independently estimate composite propagation channels relative to the first base stations 32 and relative to the second base stations 34, as part of receiving a BCMC services signal being transmitted via OFDM signaling from the first and second base stations 32 and 34 in a distributed transmit diversity environment.

The illustrated embodiment of the mobile station 12 comprises a transmit/receive antenna 50, a switch/duplexer 52, a receiver 54, a transmitter 56, one or more baseband processing circuits 58, one or more system control circuits 60, input/output interface circuits 62, and a user interface 64. It should be understood that the mobile station 12 may comprise a cellular radiotelephone, a Portable Digital Assistant, a pager, a laptop/palmtop computer or a network interface card for use in such devices, or essentially any other type of wireless communication device. The user interface details will vary with the intended use of the mobile station 12, but typical elements include a display, a keypad, a speaker, and a microphone.

Also, it should be understood that the baseband processing circuits 58, the system control circuits 60, and elements within the reciever 54 and transmitter 56, may comprise one or more special and/or general purpose processing devices. By way of non-limiting example, the baseband processing circuit(s) 58 may comprise one or more microprocessors, digital signal processors, Application Specific Integrated Circuits (ASICs), Field Programmable Gate Arrays (FPGAs), or essentially any other type of processing circuit, or any combination thereof. Note, too, that the base stations 32 and 34 may be based on hardware, software, or any combination thereof, and may include one or more microprocessor circuits supporting BCMC service transmissions, orthogonal pilot generation, radio resource management, etc.

In any case, the baseband processing circuit(s) 58 include a channel estimation circuit 66 comprising hardware, software, or any combination thereof. In the illustrated embodiment, the channel estimation circuit 66 comprises a portion of the baseband processing circuit(s) 58, wherein the baseband processing circuit(s) 58 provide received signal processing functions for (digital) baseband samples output from the reciever 54. Other functional arrangements are contemplated. For example, by way of non-limiting example, the channel estimation circuit 66 can be included in the reciever 54 in embodiments where the reciever 54 includes baseband processing circuits, e.g., demodulation and decoding circuits, in addition to front-end circuit functions such as filtering, gain, downconversion, and sampling.

The illustrated embodiment of the reciever 54 and baseband processing circuit(s) 58 are configured to receive a broadcast/multicast service signal transmitted via orthogonal frequency division multiplexing from one or more first base stations 32 and one or more second base stations 34. Further, the channel estimation circuit 66 is configured to independently estimate a first composite propagation channel relative to the first base stations 32 and a second composite propagation channel relative to the second base stations 34 based on detecting first pilot tones transmitted from the first base stations 32 and orthogonal second pilot tones transmitted from the second base stations 34.

In one embodiment, the channel estimation circuit 66 comprises one or more processing circuits configured to calculate the first composite propagation channel estimate based on combining signal samples for a first pilot tone pair received from the first base stations 32, and to calculate the second composite propagation channel estimate based on combining signal samples for a second pilot tone pair received from the second base stations 34. In this case, the channel estimation circuit 66 can be configured to implement the processing logic of Eqs. (5) and (6) above, for example.

More generally, for a received BCMC services signal being transmitted via OFDM signaling from first and second groups of geographically separated base stations, the channel estimation circuit 66 is configured to generate the first and second composite propagation channel estimates for each broadcast/multicast service data block received from the first and second base stations. As such, it should be understood that the particular channel estimation processing logic implemented in the mobile device 12 depends at least in part on the particulars of the orthogonal pilot transmission method used for the first and second base stations 32 and 34.

Broadly, the first and second base stations 32 and 34 are configured to generate orthogonal first and second space-time (or space-frequency) pilot code sequences, respectively, and are further configured to transmit the orthogonal first and second pilot code sequences in conjunction with transmitting the same broadcast/multicast service data. In correspondence with that orthogonalized pilot transmission method, the channel estimation circuit 66 resolves pilots received from the first base stations 32 and from the second base stations 34, and generates independent channel estimates for the composite propagation channel relative to the first base stations 32 and for the composite propagation channel relative to the second base stations. The independent channel estimations can then be used to improve diversity reception of the BCMC services signal being received by the mobile station 12.

Broadly, these methods of orthogonalized pilot transmission and independent channel resolution enable the transmission of broadcast services in distributed transmit diversity systems from potentially large numbers of base stations, thereby providing improved broadcast performance. Further, it should be understood that one or more embodiments of orthogonal pilot transmission as taught herein is not limited to two types of base stations—i.e., is not limited to grouping base stations broadcasting a given BCMC services signal into groups of first base stations and second base stations. Rather, higher diversity transmission levels may be used, such as a distributed transmit diversity level of four (4), where orthogonalized pilot codes sequences are defined or otherwise coordinated for first, second, third, and fourth “types” of base stations.

As an example, the one or more base stations in a first group may be transmitting pilot tone(s) while the other base stations in the second, third, and fourth groups are not. Equivalent pilot orthgonalization may be achieved for the four groups of base stations in the frequency domain. For example, length 4 orthogonal codes may be assigned as [+1, +1, +1, +1] for type 1 base stations, [+1, +1, −1, −1] for type 2 base stations, [+1, −1, +1, −1] for type 3 base stations, and [+1, −1, −1, +1] for type 4 base stations.

Of course, the present invention contemplates generalizing orthogonalized pilot transmissions to any desired level of transmit diversity needed or desired. That is, as taught herein, then, a system and method for orthogonalized pilot transmission can comprise a plurality of base station groups, including first and second groups, all transmitting a broadcast/multicast service, wherein the base station groups transmit orthogonalized pilot tones according to space-time or space-frequency coding.

With the above range of variations in mind, it should be understood that the present invention is not limited by the foregoing description, nor is it limited by the accompanying drawings. Instead, the present invention is limited only by the following claims, and their legal equivalents.

What is claimed is:

1. A method of enabling channel estimation by a remote receiver relative to a broadcast/multicast service being transmitted via orthogonal frequency division multiplexing (OFDM) from one or more first base stations and one or more geographically separated second base stations, the method comprising:
generating orthogonal first and second pilot tones; and
transmitting the first pilot tones from the one or more first base stations and transmitting the second pilot tones from the one or more second base stations.

2. The method of claim 1, wherein the first and second base stations comprise 1xEV-DO base stations in a 1xEV-DO communication network, and wherein transmitting the first pilot tones from the one or more first base stations and transmitting the second pilot tones from the one or more second base stations comprises transmitting orthogonal pilot tones from the first and second base stations according to a desired space-time or space-frequency block coding.

3. The method of claim 1, wherein generating orthogonal first and second pilot tones comprises generating a first pilot tone pair and an orthogonal second pilot tone pair, and wherein transmitting the first pilot tones from the one or more first base stations and transmitting the second pilot tones from the one or more second base stations comprises interleaving the first pilot tone pair with data tones being transmitted from the first base stations and interleaving the orthogonal second pilot tone pair with data tones being transmitted from the second base stations.

4. The method of claim 1, wherein generating orthogonal first and second pilot tones comprises generating orthogonal first and second space-time or space frequency pilot code sequences, and wherein transmitting the first pilot tones from the one or more first base stations and transmitting the second pilot tones from the one or more second base stations comprises transmitting the first pilot code sequence from the first base stations and transmitting the second pilot code sequence from the second base stations.

5. The method of claim 4, further comprising alternately transmitting the first and second pilot code sequences from the first base stations, while alternately transmitting the second and first pilot code sequences in the same data blocks of a BCMC service signal being transmitted from the second base stations.

6. The method of claim 1, wherein the first base stations and the second base stations comprises two groups in a plurality of base station groups transmitting the broadcast/multicast service, and wherein the method further comprises generating and transmitting orthogonal pilot tones among the plurality of base station groups.

7. A broadcast/multicast service system enabling channel estimation by a remote receiver relative to a broadcast/multicast service being transmitted via orthogonal frequency division multiplexing (OFDM) from one or more first base stations and one or more geographically separated second base stations included in the broadcast/multicast service system, said system comprising:
a number of first base stations configured to transmit first pilot tones in conjunction with transmitting data tones corresponding to the broadcast/multicast service; and
a number of second base stations configured to transmit second pilot tones orthogonal to the first pilot tones, in conjunction with transmitting data tones corresponding to the broadcast/multicast service.

8. The system of claim 7, wherein the first and second base stations comprise 1xEV-DO base stations in a 1xEV-DO communication network, and wherein the first base stations are configured to transmit first pilot tones interleaved with data tones and the second base stations are configured to transmit second pilot tones interleaved with the same data tones, said first and second pilot tones being orthogonal relative to each other.

9. The system of claim 8, wherein the first and second base stations transmit the first and second pilot tones synchronously in each of a plurality of successive broadcast/multicast service data blocks.

10. The system of claim 7, wherein the first and second base stations are configured to generate orthogonal first and second space-time or space-frequency pilot code sequences, respectively, and further configured to transmit the first and second pilot code sequences in conjunction with transmitting the same broadcast/multicast service data.

11. The system of claim 7, wherein the first base stations are configured to alternately transmit a first pilot tone pair and a second pilot tone pair, and wherein the second base stations are configured to alternately transmit the second pilot tone pair and the first pilot tone pair, such that when the first base stations transmit the first pilot tone pair the second base stations transmit the second pilot tone pair, and when the first base stations transmit the second pilot tone pair the second base stations transmit the first pilot tone pair.

12. The system of claim 7, wherein the system comprises a plurality of base station groups transmitting the broadcast/multicast service, including the one or more first base stations as a first one of said groups and the one or more second base stations as a second one of said groups, and further comprising generating and transmitting orthogonal pilot tones among the plurality of base station groups.

13. A mobile station comprising:
a receiver configured to receive a broadcast/multicast service signal transmitted via orthogonal frequency division multiplexing from one or more first base stations and one or more second base stations; and
a channel estimation circuit configured to independently estimate a first composite propagation channel relative to the first base stations and a second composite propagation channel relative to the second base stations based on detecting first pilot tones transmitted from the first base stations and orthogonal second pilot tones transmitted from the second base stations.

14. The mobile station of claim 13, wherein the mobile station comprises a 1xEV-DO terminal configured for operation in a 1xEV-DO wireless communication network.

15. The mobile station of claim 13, wherein the channel estimation circuit comprises one or more processing circuits configured to calculate the first composite propagation channel estimate based on combining signal samples for a first pilot tone pair received from the first base stations, and to calculate the second composite propagation channel estimate based on combining signal samples for a second pilot tone pair received from the second base stations.

16. The mobile station of claim 13, wherein the channel estimation circuit is configured to generate the first and second composite propagation channel estimates for each broadcast/multicast service data block received from the first and second base stations.
